(19) United States
(12) Patent Application Publication
(10) Pub. No.: US 2026/0031525 A1
(43) Pub. Date: Jan. 29, 2026

(54) ELECTRICAL CONNECTIONS FOR ANTENNA ELEMENTS

(71) Applicant: Meta Platforms Technologies, LLC, Menlo Park, CA (US)

(72) Inventors: Diaaaldin Bisharat, Palo Alto, CA (US); Yasuo Morimoto, Cupertino, CA (US); Javier Rodriguez De Luis, Kirkland, WA (US); Wei Huang, San Diego, CA (US); Boon Shiu, Palo Alto, CA (US); Jiang Zhu, Cupertino, CA (US); Geng Ye, Union City, CA (US)

(21) Appl. No.: 18/787,297

(22) Filed: Jul. 29, 2024

(51) Int. Cl. H01Q 1/27; G02B 27/01; H01Q 1/12; H01Q 1/48

(52) U.S. Cl. CPC H01Q 1/273; G02B 27/0176; H01Q 1/1271; H01Q 1/48; G02B 2027/0178

(57) ABSTRACT

A disclosed system may include a support structure, a lens, mounted to the support structure, an antenna structure positioned on the lens and/or the support structure, and an electrically conductive piece that grounds current from the antenna structure by inducing an electrical connection with the antenna structure. Various other wearable devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a system 100.

FIG. 2 depicts an exemplary pair of glasses (e.g., corresponding to system 100).

FIG. 3 depicts an exemplary system without the disclosed grounding mechanism.

FIG. 4 depicts an exemplary system with a grounding mechanism in a first configuration.

FIG. 5 depicts an exemplary system with a grounding mechanism in a second configuration.

FIG. 6 depicts an exemplary system with a grounding mechanism in a third configuration.

FIG. 7 depicts an exemplary cross-sectional view of the disclosed grounding mechanism according to one embodiment.

FIG. 8 depicts a planar view of the disclosed grounding mechanism according to a first embodiment.

FIG. 9 depicts a planar view of the disclosed grounding mechanism according to a second embodiment.

FIG. 10 depicts a planar view of the disclosed grounding mechanism according to a third embodiment.

FIG. 11 depicts an exemplary wearable device with the disclosed grounding mechanism according to one embodiment.

FIG. 12 depicts an exemplary current distribution of an antenna structure, according to one embodiment, resulting from the placement of the two instances of an electrically conductive piece.

FIG. 13 depicts an exemplary method of manufacture corresponding to the system of FIG. 1.

FIG. 14 depicts an exemplary augmented-reality system that may include the lens described in connection with FIGS. 1-13.

FIG. 15 depicts an exemplary virtual-reality system that may include the electronic display described in connection with FIGS. 1-13.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Many electronic devices (e.g., wearable devices such as artificial reality devices, smart glasses, smart watches, etc.) rely on proper and efficient antenna operation (e.g., to enable wireless connectivity). Often, other components of such an electronic device (e.g., components corresponding to a display or dimming functionality, battery, a speaker, etc.) coexist alongside an antenna within a finite and compact space. For each component to operate efficiently, the electronic circuitry (e.g., transmission and/or bias lines) that controls the different components should be decoupled (e.g., isolated) from each other (e.g., so that electric current from one circuit does not pass into and/or interfere with another circuit). Problematically, an antenna carries currents configured to radiate energy from the antenna to outside the electronic device. Given the relatively large size that an antenna may occupy within an electronic device, currents from the antenna structure may flow close to the electronic circuitry (e.g., the transmission and/or bias lines) of other device components, leaking energy into the electronic circuitry of the other device components and/or alternating the electric and/or magnetic field distribution on the antenna. Energy leaking into the electronic circuitry of the other device components may damage and/or hinder the operation of those components. Altering the electric and/or magnetic field distribution on the antenna may change operating conditions and/or characteristics of the antenna, deteriorating the antenna's radiation efficiency and/or deteriorating a total efficiency of the antenna.

This disclosure is generally directed to a framework for controlling (e.g., changing the flow of) current from an antenna. In some examples the framework may represent a multi-component framework that enables an antenna to coexist with other components by preventing current from the antenna from interfering with the electronic circuitry of the other components or limiting the amount of current from the antenna that may interfere with the electronic circuitry of the other components. In some examples, the framework may correspond to a device that includes (1) an electrically conductive structure (e.g., metal) that forms an antenna (and, in some instances, may also form the body of the device or part thereof) and (2) one or more additional device components (e.g., an additional antenna, an optical display, an audio module, etc.), each of which may include a conductive trace (e.g., a transmission line and/or a bias line) that is proximate to the antenna (e.g., at a distance within which a threshold level of current from the antenna flows).

In some examples, the disclosed framework may control current from an antenna using one or more electrically conductive pieces (e.g., of finite size). The electrically conductive pieces may take a variety of forms (e.g., a tab, a pad, a flex, a pin, a screw, etc.). The one or more electrically conductive pieces may represent pieces that are separate (e.g., physically discrete) from other conductive components (e.g., a transmission lines and/or a bias line) that enable the functioning of the antenna. The one or more electrically conductive pieces may make and/or induce an electrical connection between the antenna and an electrically conductive portion of a device housing the antenna (e.g., a metal portion of a frame of the device), grounding the current from the antenna. The position of the one or more electrically conductive pieces may be chosen such that current over the antenna or part thereof, which otherwise would flow near conductive traces (e.g., the transmission and/or bias lines) of other components and cause energy leakage into these conductive traces, now flows through the one or more electrically conductive pieces, which form an alternative pathway of lower resistivity for the antenna current (e.g., inducing the current to flow to the conductive portion of the device).

In some examples, the one or more electrically conductive pieces may be used to block a region of the antenna, the boundary of which carries a relatively high concentration of current, that is proximate to the conductive traces of other components. This positioning may change how current is distributed on the antenna such that the current effectively bypasses the conductive traces of the other components (e.g., entirely bypassing or substantially bypassing the conductive traces of the other conductive pathways).

In some examples, the one or more electrically conductive pieces may provide an additional degree of freedom (e.g., flexibility) to design the antenna structure and/or may be used to tune the antenna structure's impedance, resonant frequency, bandwidth, and/or radiation pattern. The antenna structure may be formed of any type of material. In some examples, the antenna structure may represent a transparent antenna (e.g., made of a metal mesh film). In one embodiment, the one or more electrically conductive pieces may be formed of a part of the antenna and/or as an extension to a part of the antenna. In other embodiments, the one or more electrically conductive pieces may be physically distinct. In some examples, the current-decoupling processes described may be combined with one or more other current-decoupling processes.

While this description focuses on an embodiment in which the electrically conductive pieces are used to shield conductive traces from the current of an antenna structure, it should be appreciated that the proposed grounding structure could be used to shield any structure, or portion of a structure, from the current of an additional structure.

Features from any of the embodiments described herein may be used in combination with one another in accordance with the general principles described herein. These and other embodiments, features, and advantages will be more fully understood upon reading the following detailed description in conjunction with the accompanying drawings and claims.

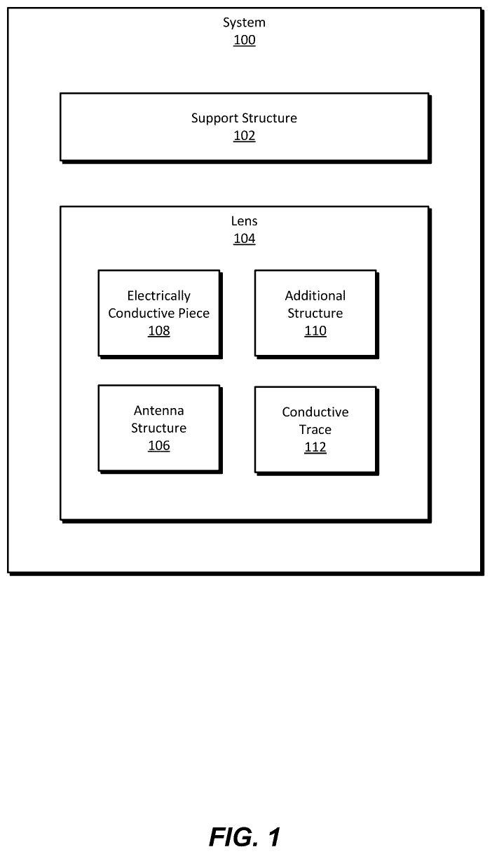

FIG. 1 illustrates one exemplary embodiment of the disclosed framework. In FIG. 1, a system 100 includes a support structure 102 mounted to a lens 104. Lens 104 and/or support structure 102 may include an antenna structure 106 (e.g., applied to and/or formed from lens 104 and/or support structure 102). System 100 may also include one or more electrically conductive pieces, such as electrically conductive piece 108. In some examples (e.g., in addition to antenna structure 106), system 100 may further include one or more additional structures (e.g., additional components), such as an additional structure 110 (e.g., applied to and/or formed from lens 104 and/or support structure 102).

Lens 104 may represent any type or form of optical substrate. Lens 104 may be formed from any optical material (e.g., polycarbonate and/or glass). In some examples, lens 104 may be configured to integrate digital information into a user's field of view, while maintaining or not maintaining optical clarity. In these examples, lens 104 may display digital information using any type of display technology (e.g., via a waveguide, a holographic film, a microdisplay, etc.).

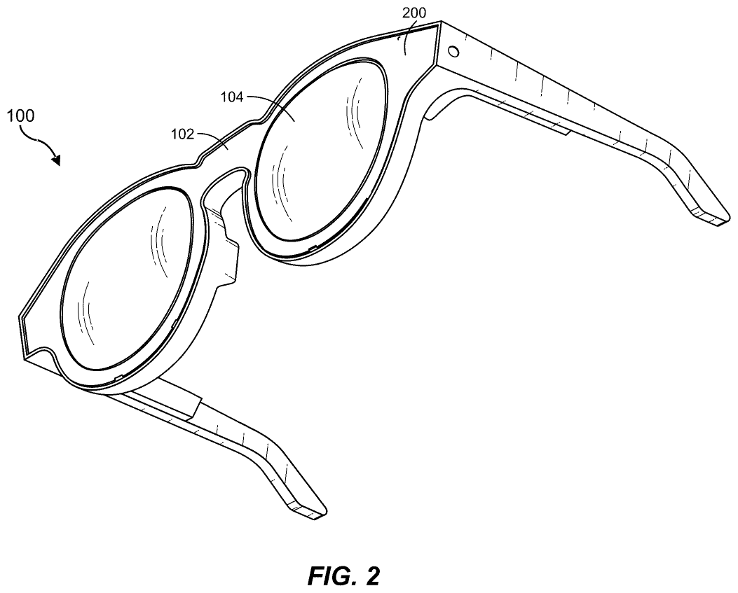

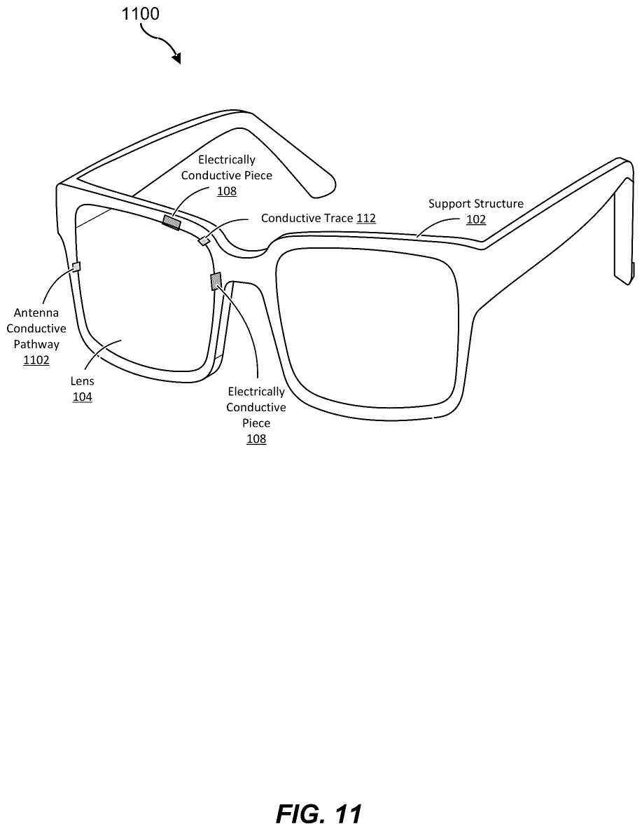

Support structure 102 may represent any type or form of structure that physically supports (e.g., houses) lens 104. In some examples, support structure 102, or a portion of support structure 102, may be formed of an electrically conductive material (e.g., metal). In some such examples, support structure 102 may represent a metallic enclosure (or an enclosure with metallic portions) that forms the body of a wearable device. In some examples, support structure 102 may represent a wearable device (or a component of a wearable device) and lens 104 may represent an electronic display placed within the wearable device. In one example, as illustrated in FIG. 2, lens 104 may represent a lens within a pair of augmented reality glass lenses 200 and support structure 102 may represent a frame (e.g., for housing lens 104). Exemplary descriptions of a wearable device will be provided later in connection with FIGS. 11, 14, and 15.

In some examples, lens 104 may include a transparent substrate and a conductive film (e.g., a film that conducts electricity) may be applied to the transparent substrate. In some such examples, the conductive film may include a support system, such as conductive metal mesh, with which one or more elements (e.g., antenna structure 106 and/or one or more additional structures such as additional structure 110) may be embedded. Additionally or alternatively, elements may be directly integrated (e.g., embedded) with the transparent substrate and/or with support structure 102. For example, elements may be casted, laminated, and/or printed onto the transparent substrate and/or onto support structure 102. In other examples, elements may be coupled to lens 104 and/or support structure 102 using any type or form of coupling technique (e.g., via any element fastening and/or adhering mechanism).

Additional structure 110 may represent any type or form of structure (e.g., a microstructure) positioned within system 100 (e.g., within lens 104 and/or support structure 102). Examples of additional structure 110 include, without limitation, an optical display, an audio module, a dimming module, a battery module, a speaker module, a microphone module, a thermal management module, an additional antenna, etc.

Antenna structure 106 may refer to any type or form of device that transmits and/or receives radio frequency signals. In some examples (e.g., in which system 100 corresponds to a wearable device such as a pair of artificial reality glasses), antenna structure 106 may enable wireless communication (e.g., enabling system 100 to establish a connection with other devices, networks, or sensors). In one example, antenna structure 106 may represent a transparent antenna (e.g., laminated onto lens 104). In some examples, antenna structure 106 may include or represent a conductive material. For example, antenna structure 106 may represent a wireless metal mesh antenna (e.g., in which the shape of the antenna is defined by a cutout in surrounding metal mesh dummy fill). Antenna structure 106 may carry current that radiates energy to outside the device.

In some examples, antenna structure 106 and/or additional structure 110 may each include one or more conductive traces (e.g., conductive pathways), such as a bias line and/or a transmission line. A conductive trace 112 for additional structure 110 is depicted in FIG. 1. The term conductive trace may refer to any type of physical pathway (e.g., route and/or channel), such as a cable, through which electrical signals may flow within a circuitry of system 100. A conductive trace may be formed from a conductive material (e.g., a material with high electrical conductivity, such as copper, silver, etc.) that facilitates the transmission of electrical currents from one point (e.g., one component) of system 100 to another. The term “bias line” may refer to any type or form of conductive trace (e.g., a wire trace) that provides a current (e.g., a constant DC voltage) to a structure. The term “transmission line” may refer to any type or form conductive trace (e.g., a wire trace) that transmits high-frequency signals (e.g., data signals and/or radio frequency signals).

Given the relatively large size that antenna structure 106 may occupy within lens 104 and/or support structure 102, currents on antenna structure 106 may flow close to the conductive traces of other device structures within system 100 (e.g., conductive trace 112 of additional structure 110). This may (1) change conditions and/or characteristics of antenna structure 106 (e.g., may alter an electric field and/or magnetic field distribution on antenna structure 106), deteriorating the radiation efficiency and/or total efficiency of antenna structure 106, and/or (2) leak energy (e.g., current flows) (e.g., into the transmission and/or bias lines of other device structures), damaging or hindering the operations of other device structures.

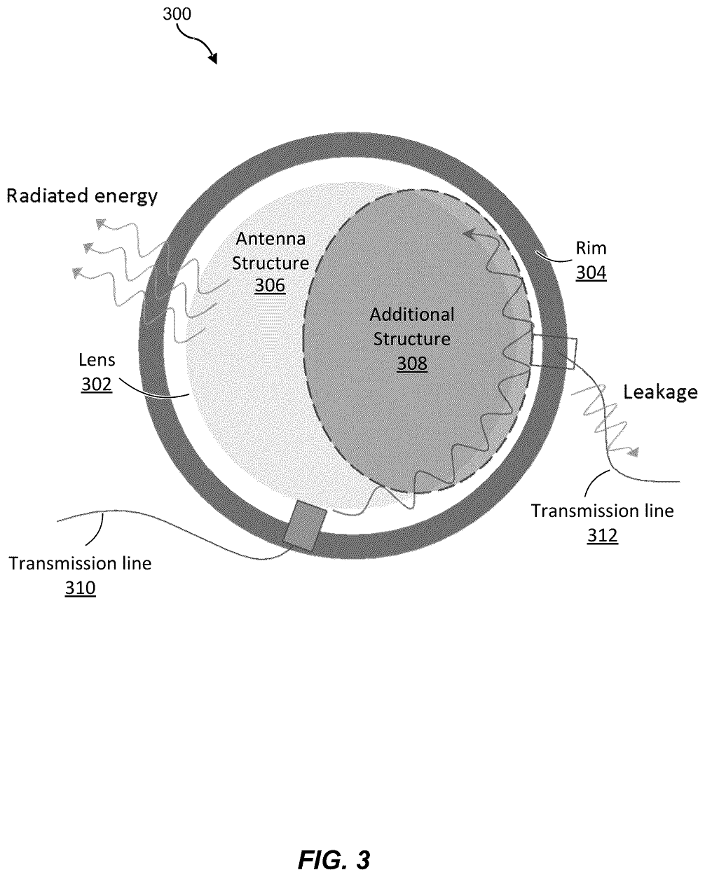

FIG. 3 illustrates a system 300 that does not include the grounding features described herein (e.g., in which there is no instance of electrically conductive piece 108). In FIG. 3, a lens 302, housed in a rim 304 of a support structure (e.g., a frame with one or more of the features of support structure 102), includes (1) an antenna structure 306 (e.g., with one or more of the features of antenna structure 106) and (2) an additional structure 308 (e.g., with one or more of the features of additional structure 110). System 300 may also include a transmission line 310 of antenna structure 306 and another transmission line 312 of additional structure 308. As shown in FIG. 3, without the grounding mechanism described herein, radiated energy from antenna structure 306 may cause current-leakage that flows into other transmission line 312.

Returning to FIG. 1 and the disclosed grounding mechanism: electrically conductive piece 108 may refer to any type or form of electrically conductive element (e.g., of finite size) that grounds current from antenna structure 106 by inducing an electrical connection between antenna structure 106 and another electrically conductive structure (e.g., an electrical connection between antenna structure 106 and an electrically conductive portion of support structure 110). In some examples, electrically conductive piece 108 may represent an element that is not, by itself, an electrical component (e.g., electrically conductive piece 108 may represent an element, such as a transmission line or a bias line, that is configured to provide power to a component and/or transmit signals between components). Electrically conductive piece 108 may reduce or eliminate the current that flows from antenna structure 106 to an area of interest (e.g., additional structure 110 or conductive trace 112 of additional structure 110) by forming an electrical pathway from antenna structure 106 to the other electrically conductive element (e.g., to the electrically conductive portion of support structure 110), causing the current to flow to the other electrically conductive element (e.g., the electrically conductive portion of support structure 110) instead of flowing to an area of interest (e.g., an area that includes conductive trace 112 of additional structure 110, such as a transmission line and/or a bias line of additional structure 110).

Electrically conductive piece 108 may create an electrical pathway from antenna structure 106 to the other electrically conductive element (e.g., to the electrically conductive portion of support structure 110) in a variety of ways. In some examples, electrically conductive piece 108 may make physical contact with both antenna structure 106 and the other electrically conductive element (e.g., the electrically conductive portion of support structure 110) such that current from antenna structure 106 flows, through electrically conductive piece 108, from antenna structure 106 to the other electrically conductive element.

In some examples, a position of electrically conductive piece 108 may be based on a position of additional structure 110 (e.g., based on a position of conductive trace 112 of additional structure 110 that has been designated as needing to be protected from the current of antenna structure 106). For example, electrically conductive piece 108 may be positioned proximate to (e.g., a designated distance from) conductive trace 112 of additional structure 110 (e.g., a transmission line and/or a bias line of additional structure 110). In some examples, this proximity (e.g., this designated distance) may represent a distance at which conductive trace 112 of additional structure 110 is successfully shielded from the current of antenna structure 106 (e.g., a distance at which current is successfully rerouted to flow to the electrically conductive portion of support structure 102 instead of flowing to the conductive pathway of additional structure 110).

In other words, in these examples, the position of electrically conductive piece 108 may be selected such that current over antenna structure 106 (or part thereof), which otherwise would flow near conductive trace 112 (e.g., a transmission line and/or bias line) of additional structure 110 (causing energy leakage into the conductive trace), now flows through electrically conductive piece 108, which forms an alternative pathway of lower resistivity for current than conductive trace 112 of additional structure 110. In some examples, electrically conductive piece 108 can be used to block a region of antenna structure 106, the boundary of which carries relatively high concentration of current, that is around on or more (e.g., all) of the conductive traces of other components (e.g., additional structure 110). In these examples, the position of the one or more electrically conductive pieces may change how current is distributed on antenna structure 106 such that the current of antenna structure 106 bypasses the one or more electrical pathways.

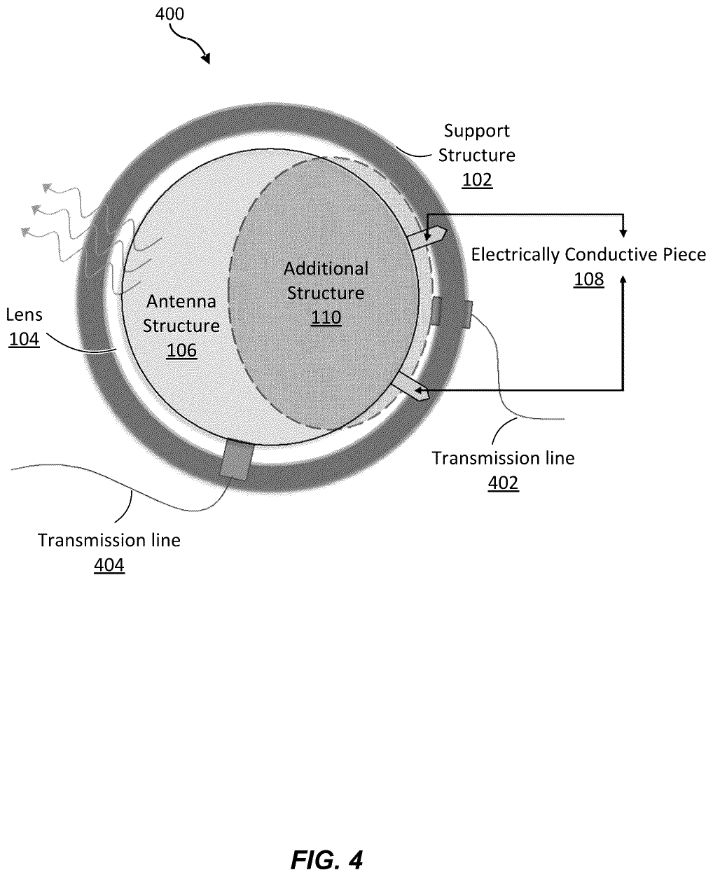

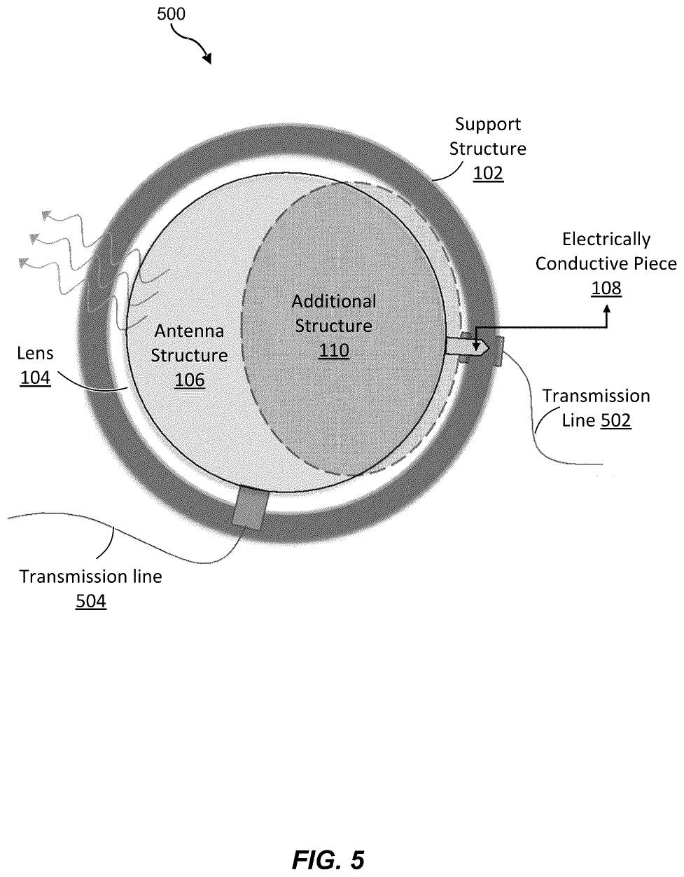

In some examples, electrically conductive piece 108 may be positioned to a side of conductive trace 112 of additional structure 110. In one embodiment, electrically conductive piece 108 may be configured to surround conductive trace 112. In one such embodiment, electrically conductive piece 108 may include two electrically conductive pieces (a first instance of electrically conductive piece 108 and a second instance of electrically conductive piece 108). The first instance may be positioned on a first side of conductive trace 112 and second instance may be positioned to a second side of conductive trace 112. This configuration minimizes the antenna current that would flow to the area between the two electrically conductive pieces (e.g., thereby reducing or eliminating the current that can flow to conductive trace 112 occupying the area between the two instances of electrically conductive piece 108). In an additional or alternative embodiment, electrically conductive piece 108 may be positioned over the top/bottom of a conductive pathway of additional structure 110 and/or over the top/bottom of a conductive pathway of antenna structure 106. Exemplary depictions of these embodiments will be described later in connection with FIGS. 4 and 5.

In some examples, electrically conductive piece 108 can be formed as part of antenna structure 106 and/or as an extension of antenna structure 106. Additionally or alternatively, electrically conductive piece 108 can represent a separate component (e.g., that makes physical contact with antenna structure 106). In some such examples, system 100 may include a variety of (e.g., at least four) separate electrically conductive components: (1) support structure 102 (at least a portion of which may be electrically conductive), (2) a conductive trace (e.g., a transmission line and/or a bias line) for antenna structure 106, (3) a conductive trace (e.g., a transmission line and/or a bias line) for additional structure 110, and (4) electrically conductive piece 108 (e.g., as depicted in FIGS. 4, 5, and 11).

Electrically conductive piece 108 can take any form. Examples of such a form include, without limitation, a tab, a pad, a pin, and/or a screw. In some examples, electrically conductive piece 108 may be referred to as a shorting pin.

FIGS. 4-5 illustrate two exemplary positions for the electrically conductive pieces described herein. In system 400 depicted in FIG. 4, there are two electrically conductive pieces (i.e., electrically conductive piece 108 includes a first electrically conductive piece and a second electrically conductive piece). The two electrically conductive pieces are positioned to each side of a transmission line 402 of additional structure 110 (e.g., between a transmission line 404 of antenna structure 106 and a transmission line 402 of additional structure 110) such that the two electrically conductive pieces make and/or induce an electrical connection between antenna structure 106 and an electrically conductive portion of support structure 102 (e.g., a metal rim of a frame in this figure), thereby grounding electrical current from antenna structure 106 that would otherwise leak into transmission line 402 of additional structure 110, interfering with the operation of additional structure 110.

In system 500 depicted in FIG. 5, electrically conductive piece 108 is positioned directly over an electrical pathway (transmission line 502) of additional structure 110 (e.g., with a gap between the electrical pathway of additional structure 110 and electrically conductive piece 108). FIG. 5 also depicts a transmission line 504 of antenna structure 106.

In some examples (not depicted in a figure), a disclosed system may include both (1) an electrically conductive piece positioned to the side of a conductive trace of additional structure 110 (e.g., the configuration depicted in FIG. 4) and (2) an electrically conductive piece positioned directly over a conductive trace of additional structure 110 (e.g., the configuration depicted in FIG. 5).

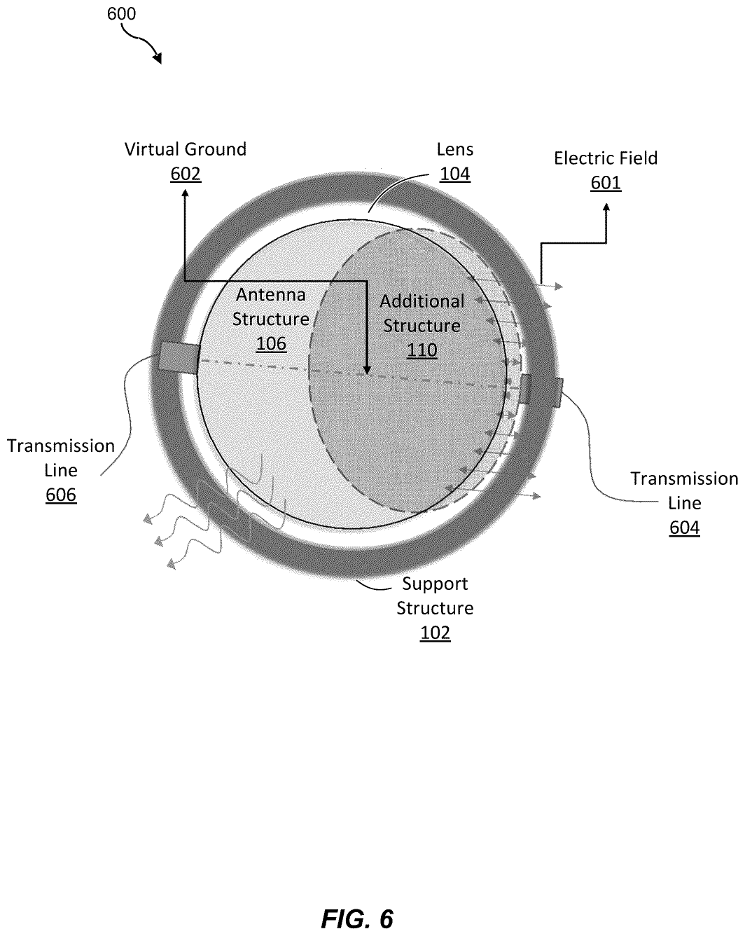

In some examples, current distribution from antenna structure 106 may be controlled using a virtual ground (e.g., in lieu of and/or in addition to the one or more electrically conductive pieces). Virtual ground herein may refer to locations over and/or near an antenna structure where the current of the antenna has maximum intensity, whereas the voltage and respective induced electric fields have minimum intensity. FIG. 6 depicts a system 600 in which current (and accompanying electric fields 601) of antenna structure 106 is controlled using a virtual ground. In FIG. 6, a virtual ground 602 is realized over an electrical pathway (e.g., transmission line 604) of additional structure 110 (e.g., between transmission line 604 of additional structure 110 and a transmission line 606 of antenna structure 106). The virtual ground may be located at a variety of positions (e.g., at a center line of an antenna pattern of antenna structure 106, at a position where a null and/or minimum electrical field exists, etc.). Having the virtual ground's location at/near a region of interest (e.g., transmission line 604) may reduce energy leakage into additional structural 110.

The virtual ground may be realized in a variety of ways. In some examples, a process for realizing the virtual ground may include generating a reference point in a circuit that behaves as if it were at ground potential (0 volts), even though the reference point is not directly connected to an actual ground. The virtual ground may be realized using a variety of virtual grounding techniques (e.g., using an operational amplifier and/or a voltage divider). In some examples, the antenna may have current distribution in the form of a standing wave, in which case it has an intrinsic virtual ground (i.e. naturally occurring).

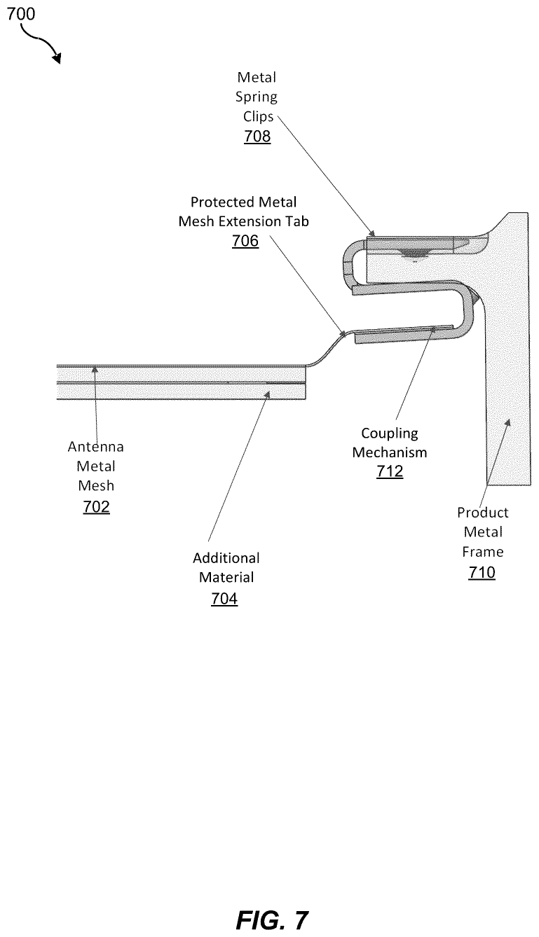

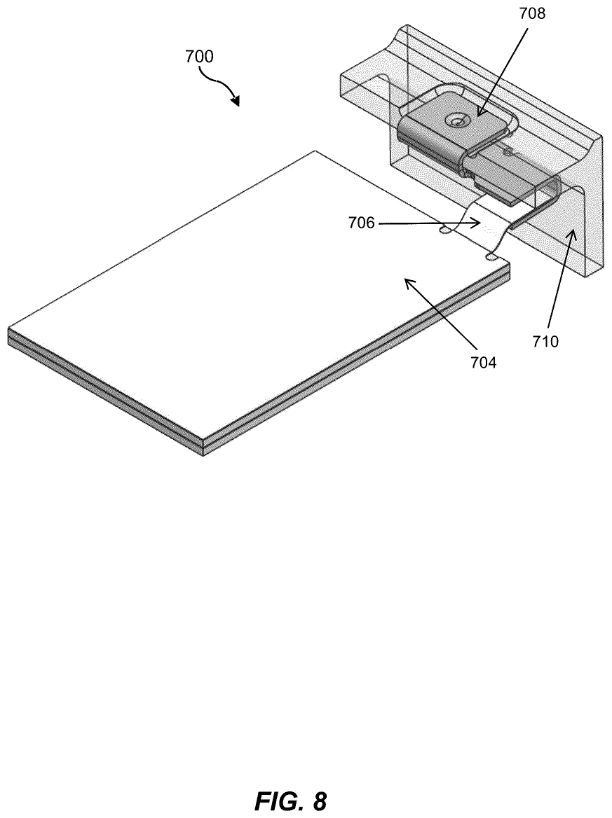

FIG. 7 depicts a cross-sectional view of certain components of an exemplary system 700 (e.g., corresponding to one embodiment of system 100), which may operate in connection with the disclosed grounding framework. System 700 illustrates an exemplary embodiment in which electrically conductive piece 108 is a set of two metal spring clips. In system 700, antenna structure 106 is an antenna metal mesh 702 integrated with lens 104. Lens 104 may also include additional material 704 (e.g., Indium Tim Oxide (ITO) and/or a dielectric-metal-dielectric (DMD) layer associated with an additional structure such as additional structure 110). In exemplary system 700, the metal mesh of antenna structure 106 extends via a protected metal mesh extension tab 706, which is coupled to metal spring clips 708 (corresponding to electrically conductive piece 108). Metal spring clips 708 are, in turn, coupled to support structure 102 (support structure 102 is a product metal frame 710 in FIG. 7). Metal mesh extension tab 706 may be coupled to metal spring clips 708 (and/or to lens 104) using any type of coupling mechanism 712 (e.g., via an adhesive such as an Anisotropic Conductive Film (ACF), conductive tape, an Ag-paste, etc.). FIG. 8 depicts a planar view of system 700, corresponding to FIG. 7.

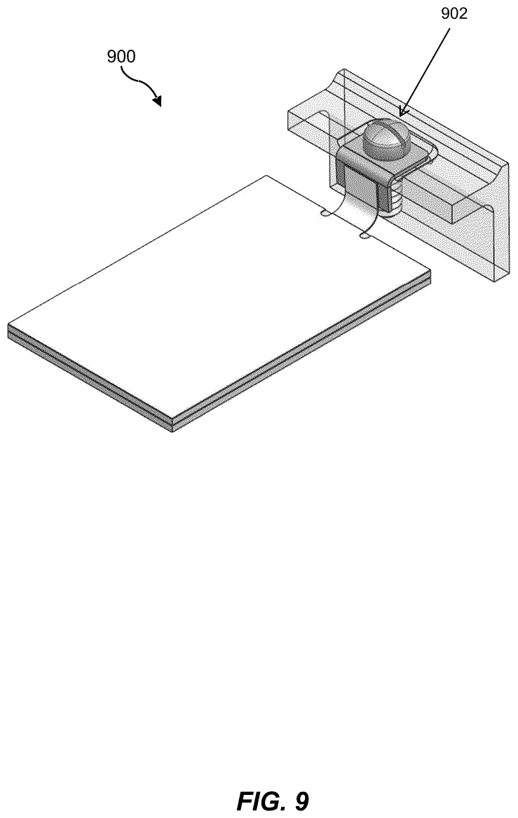

FIG. 9 depicts a planar view of certain components of an exemplary system 900, which may operate in connection with the disclosed grounding framework. System 900 illustrates an exemplary embodiment in which electrically conductive piece 108 is a screw 902 and/or an electrically conductive piece fastened to the product metal frame via screw 902. The other elements of system 900 align with the elements depicted system 700.

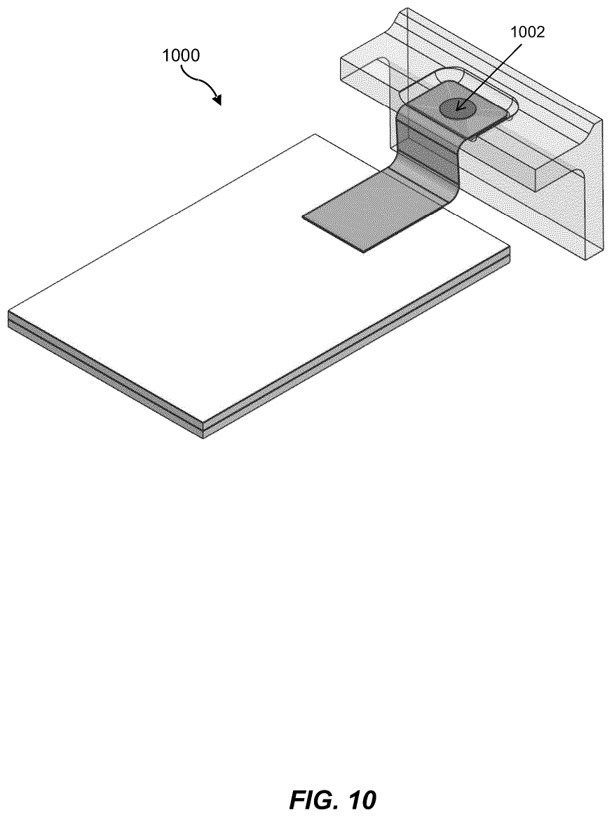

FIG. 10 depicts a planar view of certain components of an exemplary system 1000, which may operate in connection with the disclosed grounding framework. System 1000 illustrates an exemplary embodiment in which electrically conductive piece 108 is an electrically conductive solder 1002 (e.g., applied to the product metal frame via laser soldering) and/or an electrically conductive piece fastened to the product metal frame via conductive solder 1002. The other elements of system 900 align with the elements depicted system 700.

FIG. 11 depicts an exemplary wearable device 1100 (a pair of glasses) that corresponds to one exemplary embodiment of system 100. As shown in FIG. 11, conductive trace 112 (shown) of additional structure 110 (not shown) is surrounded by two instances of electrically conductive piece 108. Antenna structure 106 (not shown) is positioned within lens 104, which is connected to an antenna conductive trace 1102.

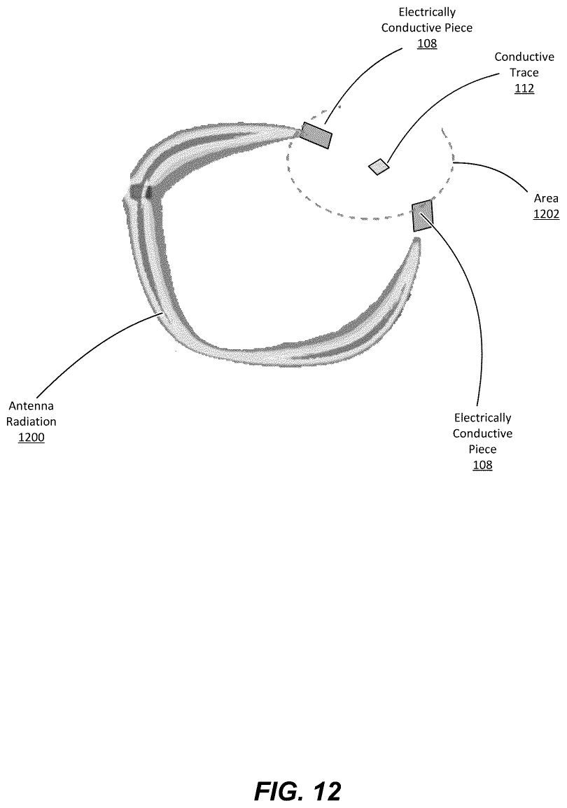

FIG. 12 shows an exemplary current distribution 1200 of antenna structure 106, according to one embodiment, resulting from the placement of the two instances of electrically conductive pieces (e.g., according to the configuration shown in FIGS. 4 and 11 and described in connection with those figures). As shown in FIG. 12, current 1200 from antenna structure 106 is directed away from area 1202 (effectively shielding conductive trace 112 from current 1200), instead of continuing all the way around a rim of support structure 102.

The disclosed grounding framework corresponding to FIGS. 1-12 provide a variety of improvements. The framework provides an additional degree of freedom (e.g., flexibility) to design antenna structure 106 (e.g., enabling antenna structure 106 to be positioned in closer proximity to other components without compromising the performance of antenna structure 106 or the other components). Additionally, in some examples, the one or more electrically conductive pieces may be used to tune antenna structure 106's impedance, resonant frequency, bandwidth, and/or radiation pattern.

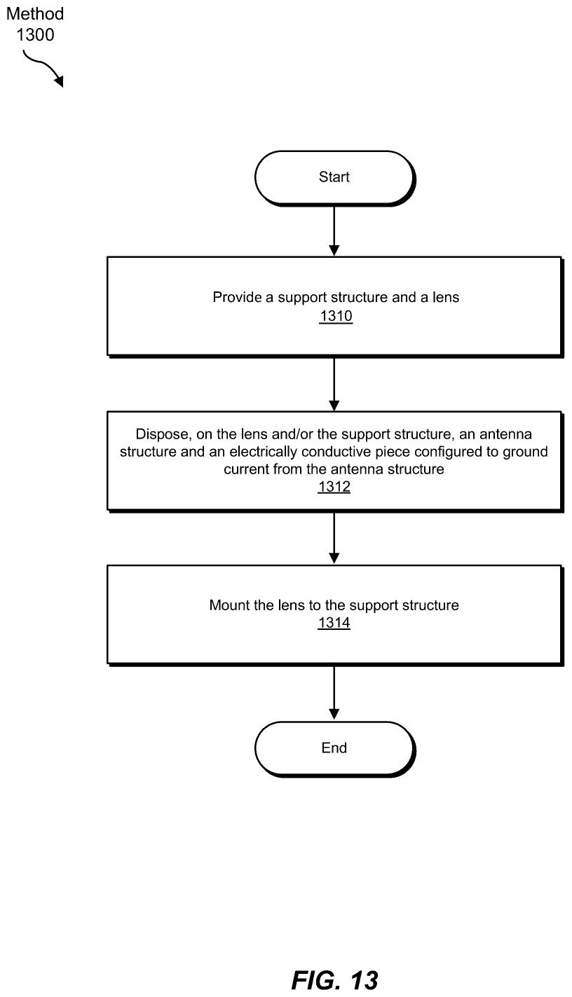

FIG. 13 depicts an exemplary method 1300 of manufacture (e.g., corresponding to system 100 of FIG. 1). At step 1310, one or more of the systems described herein may provide a support structure (support structure 102 in FIG. 1) and a lens (e.g., lens 104 in FIG. 1). Then, at step 1312, one or more of the systems described herein may dispose, on the lens and/or the support structure, an antenna structure (e.g., antenna structure 106 in FIG. 1), and an electrically conductive piece (e.g., electrically conductive piece 108 in FIG. 1) configured to ground current from the antenna structure (e.g., by inducing an electrical connection with the antenna structure). Finally, at step 1314, one or more of the systems may mount the lens to the support structure. The one or more systems described herein may perform the steps of method 1300 using any of the systems, processes, elements, or features described herein (e.g., in connection with FIGS. 1-12 and 14-15).

As mentioned previously, the disclosed framework may employ a number of processes for mitigating antenna interference (e.g., in addition to the strategies described above). In some examples, these processes may include optimizing the device architecture, systems requirements, and/or available functionalities to reach a compromise between the wireless performance and the performance of other components. In one embodiment, these processes may include limiting the choice of antenna types to those that are less likely to carry strong current over a large area. Additionally or alternatively, these processes may include placing the antenna far from surrounding transmission lines, minimizing the antenna size, and/or adding filter components (e.g., RF chokes) to block high frequency current from passing through specific transmission lines.

### EXAMPLE EMBODIMENTS

Example 1: A system including a support structure, a lens, mounted to the support structure, an antenna structure positioned on the lens and/or the support structure, and an electrically conductive piece that grounds current from the antenna structure by inducing an electrical connection with the antenna structure.

Example 2: The system of example 1, where the electrically conductive piece is in physical contact with both the antenna structure and an electrically conductive portion of the support structure, and grounding the current from the antenna structure by inducing the electrical connection with the antenna structure including inducing an electrical connection between the antenna structure and the electrically conductive portion of the support structure.

Example 3: The system of examples 1-2, further including an additional structure positioned on the lens and/or the support structure.

Example 4: The system of example 3, where the electrically conductive piece is positioned at a designated distance from a conductive pathway of the additional structure.

Example 5: The system of examples 3-4, where the electrically conductive piece includes a first electrically conductive piece and a second electrically conductive piece, and the first electrically conductive piece is positioned on a first side of the conductive pathway of the additional structure, at a first designated distance from the conductive pathway, and the second electrically conductive piece is positioned on a second side of the conductive pathway of the additional structure, at a second designated distance from the conductive pathway.

Example 6: The system of examples 4-5, where the electrically conductive piece is positioned directly over the conductive pathway of the additional structure.

Example 7: The system of examples 3-6, where the additional structure represents and/or includes an optical display, an audio module, a dimming module, a battery module, a speaker module, a microphone module, a thermal management module, and/or an additional antenna.

Example 8: The system of examples 1-7, where the electrically conductive piece represents and/or includes an electrically conductive tab, an electrically conductive spring, an electrically conductive pin, an electrically conductive pad, an electrically conductive flex, and/or an electrically conductive screw.

Example 9: The system of examples 1-8, further including a virtual ground configured to ground the current from the antenna structure.

Example 10: A wearable device including a support structure, a lens, mounted to the support structure, an antenna structure positioned on the lens and/or the support structure, and an electrically conductive piece that grounds current from the antenna structure by inducing an electrical connection with the antenna structure.

Example 11: The wearable device of example 10, where the electrically conductive piece is in physical contact with both the antenna structure and an electrically conductive portion of the support structure and grounding the current from the antenna structure by inducing an electrical connection with the antenna structure including inducing an electrical connection between the antenna structure and the electrically conductive portion of the support structure.

Example 12: The wearable device of examples 10-11, further including an additional structure positioned on the lens and/or the support structure.

Example 13: The wearable device of example 12, where the electrically conductive piece is positioned at a designated distance from a conductive trace of the additional structure.

Example 14: The wearable device of examples 12-13, where the electrically conductive piece includes a first electrically conductive piece and a second electrically conductive piece, and the first electrically conductive piece is positioned on a first side of the conductive trace of the additional structure, at a first designated distance from the conductive trace, and the second electrically conductive piece is positioned on a second side of the conductive pathway of the additional structure, at a second designated distance from the conductive trace.

Example 15: The wearable device of examples 13-14, where the electrically conductive piece is positioned directly over the conductive trace of the additional structure.

Example 16: The wearable device of examples 10-15, where the electrically conductive piece represents and/or includes an electrically conductive tab, an electrically conductive spring, an electrically conductive pin, an electrically conductive pad, an electrically conductive flex, and/or an electrically conductive screw.

Example 17: A method of manufacturing including providing a support structure and a lens, disposing, on the lens and/or the support structure, an antenna structure and an electrically conductive piece configured to ground current from the antenna structure by inducing an electrical connection with the antenna structure, and mounting the lens to the support structure.

Example 18: The method of manufacturing of example 17, where disposing the electrically conductive piece on the lens and/or the support structure includes disposing the electrically conductive piece such that the electrically conductive piece is in physical contact with both the antenna structure and an electrically conductive portion of the support structure.

Example 19: The method of manufacturing of examples 17-18, where the method further includes disposing an additional structure on the lens and/or the support structure, the electrically conductive piece includes a first electrically conductive piece and a second electrically conductive piece, and disposing the electrically conductive piece includes disposing the first electrically conductive piece on a first side of a conductive trace of the additional structure, at a first designated distance from the conductive trace, and disposing the second electrically conductive piece on a second side of the conductive trace of the additional structure, at a second designated distance from the conductive trace.

Example 20: The method of manufacturing of examples 17-19, where the method further includes disposing an additional structure on the lens and/or the support structure and disposing the electrically conductive piece includes disposing the electrically conductive piece directly over a conductive pathway of the additional structure.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof.

Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

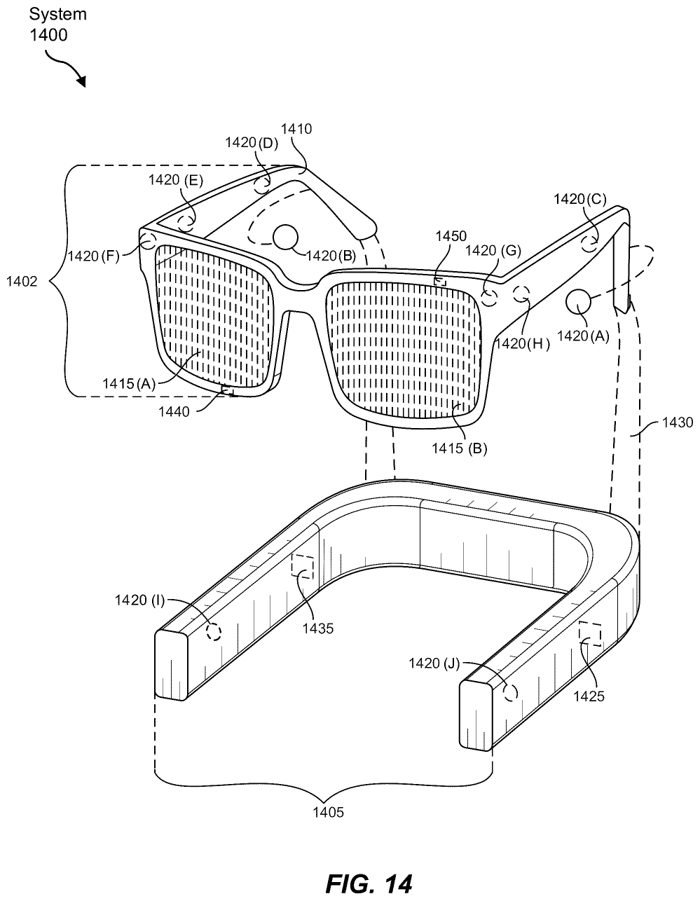

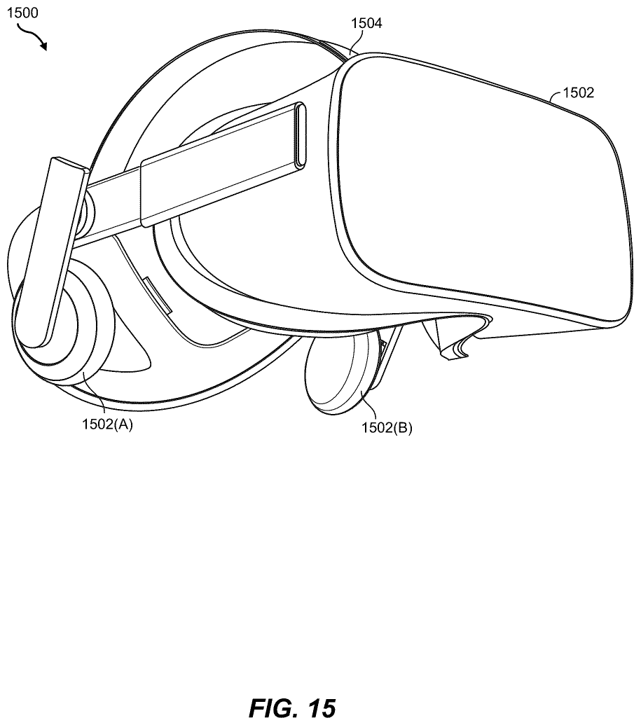

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1400 in FIG. 14) or that visually immerses a user in an artificial reality (such as, e.g., virtual-reality system 1500 in FIG. 15). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 14, augmented-reality system 1400 may include an eyewear device 1402 with a frame 1410 configured to hold a left display device 1415(A) and a right display device 1415(B) in front of a user's eyes. Display devices 1415(A) and 1415(B) may act together or independently to present an image or series of images to a user. While augmented-reality system 1400 includes two displays, embodiments of this disclosure may be implemented in augmented-reality systems with a single NED or more than two NEDs.

In some embodiments, augmented-reality system 1400 may include one or more sensors, such as sensor 1440. Sensor 1440 may generate measurement signals in response to motion of augmented-reality system 1400 and may be located on substantially any portion of frame 1410. Sensor 1440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1400 may or may not include sensor 1440 or may include more than one sensor. In embodiments in which sensor 1440 includes an IMU, the IMU may generate calibration data based on measurement signals from sensor 1440. Examples of sensor 1440 may include, without limitation, accelerometers, gyroscopes, magnetometers, other suitable types of sensors that detect motion, sensors used for error correction of the IMU, or some combination thereof.

In some examples, augmented-reality system 1400 may also include a microphone array with a plurality of acoustic transducers 1420(A)-1420(J), referred to collectively as acoustic transducers 1420. Acoustic transducers 1420 may represent transducers that detect air pressure variations induced by sound waves. Each acoustic transducer 1420 may be configured to detect sound and convert the detected sound into an electronic format (e.g., an analog or digital format). The microphone array in FIG. 14 may include, for example, ten acoustic transducers: 1420(A) and 1420(B), which may be designed to be placed inside a corresponding ear of the user, acoustic transducers 1420(C), 1420(D), 1420(E), 1420(F), 1420(G), and 1420(H), which may be positioned at various locations on frame 1410, and/or acoustic transducers 1420(I) and 1420(J), which may be positioned on a corresponding neckband 1405.

In some embodiments, one or more of acoustic transducers 1420(A)-(J) may be used as output transducers (e.g., speakers). For example, acoustic transducers 1420(A) and/or 1420(B) may be earbuds or any other suitable type of headphone or speaker.

The configuration of acoustic transducers 1420 of the microphone array may vary. While augmented-reality system 1400 is shown in FIG. 14 as having ten acoustic transducers 1420, the number of acoustic transducers 1420 may be greater or less than ten. In some embodiments, using higher numbers of acoustic transducers 1420 may increase the amount of audio information collected and/or the sensitivity and accuracy of the audio information. In contrast, using a lower number of acoustic transducers 1420 may decrease the computing power required by an associated controller 1450 to process the collected audio information. In addition, the position of each acoustic transducer 1420 of the microphone array may vary. For example, the position of an acoustic transducer 1420 may include a defined position on the user, a defined coordinate on frame 1410, an orientation associated with each acoustic transducer 1420, or some combination thereof.

Acoustic transducers 1420(A) and 1420(B) may be positioned on different parts of the user's ear, such as behind the pinna, behind the tragus, and/or within the auricle or fossa. Or, there may be additional acoustic transducers 1420 on or surrounding the ear in addition to acoustic transducers 1420 inside the ear canal. Having an acoustic transducer 1420 positioned next to an ear canal of a user may enable the microphone array to collect information on how sounds arrive at the ear canal. By positioning at least two of acoustic transducers 1420 on either side of a user's head (e.g., as binaural microphones), augmented-reality system 1400 may simulate binaural hearing and capture a 3D stereo sound field around about a user's head. In some embodiments, acoustic transducers 1420(A) and 1420(B) may be connected to augmented-reality system 1400 via a wired connection 1430, and in other embodiments acoustic transducers 1420(A) and 1420(B) may be connected to augmented-reality system 1400 via a wireless connection (e.g., a BLUETOOTH connection). In still other embodiments, acoustic transducers 1420(A) and 1420(B) may not be used at all in conjunction with augmented-reality system 1400.

Acoustic transducers 1420 on frame 1410 may be positioned in a variety of different ways, including along the length of the temples, across the bridge, above or below display devices 1415(A) and 1415(B), or some combination thereof. Acoustic transducers 1420 may also be oriented such that the microphone array is able to detect sounds in a wide range of directions surrounding the user wearing the augmented-reality system 1400. In some embodiments, an optimization process may be performed during manufacturing of augmented-reality system 1400 to determine relative positioning of each acoustic transducer 1420 in the microphone array.

In some examples, augmented-reality system 1400 may include or be connected to an external device (e.g., a paired device), such as neckband 1405. Neckband 1405 generally represents any type or form of paired device. Thus, the following discussion of neckband 1405 may also apply to various other paired devices, such as charging cases, smart watches, smart phones, wrist bands, other wearable devices, hand-held controllers, tablet computers, laptop computers, other external compute devices, etc.

As shown, neckband 1405 may be coupled to eyewear device 1402 via one or more connectors. The connectors may be wired or wireless and may include electrical and/or non-electrical (e.g., structural) components. In some cases, eyewear device 1402 and neckband 1405 may operate independently without any wired or wireless connection between them. While FIG. 14 illustrates the components of eyewear device 1402 and neckband 1405 in example locations on eyewear device 1402 and neckband 1405, the components may be located elsewhere and/or distributed differently on eyewear device 1402 and/or neckband 1405. In some embodiments, the components of eyewear device 1402 and neckband 1405 may be located on one or more additional peripheral devices paired with eyewear device 1402, neckband 1405, or some combination thereof.

Pairing external devices, such as neckband 1405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1400 may be provided by a paired device or shared between a paired device and an eyewear device, thus reducing the weight, heat profile, and form factor of the eyewear device overall while still retaining desired functionality.

For example, neckband 1405 may allow components that would otherwise be included on an eyewear device to be included in neckband 1405 since users may tolerate a heavier weight load on their shoulders than they would tolerate on their heads. Neckband 1405 may also have a larger surface area over which to diffuse and disperse heat to the ambient environment. Thus, neckband 1405 may allow for greater battery and computation capacity than might otherwise have been possible on a stand-alone eyewear device. Since weight carried in neckband 1405 may be less invasive to a user than weight carried in eyewear device 1402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1405 may be communicatively coupled with eyewear device 1402 and/or to other devices. These other devices may provide certain functions (e.g., tracking, localizing, depth mapping, processing, storage, etc.) to augmented-reality system 1400. In the embodiment of FIG. 14, neckband 1405 may include two acoustic transducers (e.g., 1420(l) and 1420(J)) that are part of the microphone array (or potentially form their own microphone subarray). Neckband 1405 may also include a controller 1425 and a power source 1435.

Acoustic transducers 1420(l) and 1420(J) of neckband 1405 may be configured to detect sound and convert the detected sound into an electronic format (analog or digital). In the embodiment of FIG. 14, acoustic transducers 1420(l) and 1420(J) may be positioned on neckband 1405, thereby increasing the distance between the neckband acoustic transducers 1420(I) and 1420(J) and other acoustic transducers 1420 positioned on eyewear device 1402. In some cases, increasing the distance between acoustic transducers 1420 of the microphone array may improve the accuracy of beamforming performed via the microphone array. For example, if a sound is detected by acoustic transducers 1420(C) and 1420(D) and the distance between acoustic transducers 1420(C) and 1420(D) is greater than, e.g., the distance between acoustic transducers 1420(D) and 1420(E), the determined source location of the detected sound may be more accurate than if the sound had been detected by acoustic transducers 1420(D) and 1420(E).

Controller 1425 of neckband 1405 may process information generated by the sensors on neckband 1405 and/or augmented-reality system 1400. For example, controller 1425 may process information from the microphone array that describes sounds detected by the microphone array. For each detected sound, controller 1425 may perform a direction-of-arrival (DOA) estimation to estimate a direction from which the detected sound arrived at the microphone array. As the microphone array detects sounds, controller 1425 may populate an audio data set with the information.

In embodiments in which augmented-reality system 1400 includes an inertial measurement unit, controller 1425 may compute all inertial and spatial calculations from the IMU located on eyewear device 1402. A connector may convey information between augmented-reality system 1400 and neckband 1405 and between augmented-reality system 1400 and controller 1425. The information may be in the form of optical data, electrical data, wireless data, or any other transmittable data form. Moving the processing of information generated by augmented-reality system 1400 to neckband 1405 may reduce weight and heat in eyewear device 1402, making it more comfortable to the user.

Power source 1435 in neckband 1405 may provide power to eyewear device 1402 and/or to neckband 1405. Power source 1435 may include, without limitation, lithium-ion batteries, lithium-polymer batteries, primary lithium batteries, alkaline batteries, or any other form of power storage. In some cases, power source 1435 may be a wired power source. Including power source 1435 on neckband 1405 instead of on eyewear device 1402 may help better distribute the weight and heat generated by power source 1435.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1500 in FIG. 15, that mostly or completely covers a user's field of view. Virtual-reality system 1500 may include a front rigid body 1502 and a band 1504 shaped to fit around a user's head. Virtual-reality system 1500 may also include output audio transducers 1506(A) and 1506(B). Furthermore, while not shown in FIG. 15, front rigid body 1502 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1500 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented reality system 900 and/or virtual-reality system 1500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world.

Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a support structure;
a lens, mounted to the support structure;
an antenna structure positioned on at least one of the lens or the support structure; and
an electrically conductive piece that grounds current from the antenna structure by inducing an electrical connection with the antenna structure.

2. The system of claim 1, wherein:
the electrically conductive piece is in physical contact with both the antenna structure and an electrically conductive portion of the support structure; and
grounding the current from the antenna structure by inducing the electrical connection with the antenna structure comprising inducing an electrical connection between the antenna structure and the electrically conductive portion of the support structure.

3. The system of claim 1, further comprising an additional structure positioned on at least one of the lens or the support structure.

4. The system of claim 3, wherein the electrically conductive piece is positioned at a designated distance from a conductive trace of the additional structure.

5. The system of claim 4, wherein:
the electrically conductive piece comprises a first electrically conductive piece and a second electrically conductive piece; and
the first electrically conductive piece is positioned on a first side of the conductive trace of the additional structure, at a first designated distance from the conductive trace, and the second electrically conductive piece is positioned on a second side of the conductive trace of the additional structure, at a second designated distance from the conductive trace.

6. The system of claim 4, wherein the electrically conductive piece is positioned directly over the conductive trace of the additional structure.

7. The system of claim 3, wherein the additional structure comprises at least one of:
an optical display;
an audio module;
a dimming module;
a battery module;
a speaker module;
a microphone module;
a thermal management module; or
an additional antenna.

8. The system of claim 1, wherein the electrically conductive piece comprises at least one of:
an electrically conductive tab;
an electrically conductive spring;
an electrically conductive pin;
an electrically conductive pad;
an electrically conductive flex; or
an electrically conductive screw.

9. The system of claim 1, further comprising a virtual ground configured to ground the current from the antenna structure.

10. A wearable device comprising:
a support structure;
a lens, mounted to the support structure;
an antenna structure positioned on at least one of the lens or the support structure; and
an electrically conductive piece that grounds current from the antenna structure by inducing an electrical connection with the antenna structure.

11. The wearable device of claim 10, wherein:
the electrically conductive piece is in physical contact with both the antenna structure and an electrically conductive portion of the support structure; and
grounding the current from the antenna structure by inducing an electrical connection with the antenna structure comprising inducing an electrical connection between the antenna structure and the electrically conductive portion of the support structure.

12. The wearable device of claim 10, further comprising an additional structure positioned on at least one of the lens or the support structure.

13. The wearable device of claim 12, wherein the electrically conductive piece is positioned at a designated distance from a conductive trace of the additional structure.

14. The wearable device of claim 13, wherein:
the electrically conductive piece comprises a first electrically conductive piece and a second electrically conductive piece; and
the first electrically conductive piece is positioned on a first side of the conductive trace of the additional structure, at a first designated distance from the conductive trace, and the second electrically conductive piece is positioned on a second side of the conductive trace of the additional structure, at a second designated distance from the conductive trace.

15. The wearable device of claim 13, wherein the electrically conductive piece is positioned directly over the conductive trace of the additional structure.

16. The wearable device of claim 10, wherein the electrically conductive piece comprises at least one of:
an electrically conductive tab;
an electrically conductive spring;
an electrically conductive pin;
an electrically conductive pad;
an electrically conductive flex; or
an electrically conductive screw.

17. A method of manufacturing comprising:
providing a support structure and a lens;
disposing, on at least one of the lens or the support structure, an antenna structure and an electrically conductive piece configured to ground current from the antenna structure by inducing an electrical connection with the antenna structure; and
mounting the lens to the support structure.

18. The method of manufacturing of claim 17, wherein disposing the electrically conductive piece on at least one of the lens or the support structure comprises disposing the electrically conductive piece such that the electrically conductive piece is in physical contact with both the antenna structure and an electrically conductive portion of the support structure.

19. The method of manufacturing of claim 17, wherein:
the method further comprises disposing an additional structure on at least one of the lens or the support structure;
the electrically conductive piece comprises a first electrically conductive piece and a second electrically conductive piece; and
disposing the electrically conductive piece comprises:
disposing the first electrically conductive piece on a first side of a conductive trace of the additional structure, at a first designated distance from the conductive trace; and
disposing the second electrically conductive piece on a second side of the conductive trace of the additional structure, at a second designated distance from the conductive trace.

20. The method of manufacturing of claim 17, wherein:
the method further comprises disposing an additional structure on at least one of the lens or the support structure; and
disposing the electrically conductive piece comprises disposing the electrically conductive piece directly over a conductive trace of the additional structure.
